(19) United States
(12) Patent Application Publication
(10) Pub. No.: US 2025/0246652 A1
(43) Pub. Date: Jul. 31, 2025

(54) REDOX FLOW BATTERY SYSTEM AND METHOD FOR OPERATING SAME

(71) Applicant: LIVA Power Management Systems GmbH, Frankfurt am Main (DE)

(72) Inventors: Thomas Lüth, Freiburg (DE); Christian Hättich, Freiburg (DE); Markus Bannwarth, Freiburg (DE); Jens Kaufmann, Freiburg (DE)

(21) Appl. No.: 18/856,551

(22) PCT Filed: Apr. 5, 2023
(86) PCT No.: PCT/EP2023/058919

§ 371 Date: Oct. 11, 2024

(30) Foreign Application Priority Data
Apr. 14, 2022 (DE) 10 2022 109 193.7

(51) Int. Cl. H01M 8/04746; H01M 8/04186; H01M 8/04537; H01M 8/18

(52) U.S. Cl. CPC H01M 8/04753; H01M 8/04186; H01M 8/04544; H01M 8/04574; H01M 8/188

(57) ABSTRACT

The invention provides a method of operating a redox flow battery system, wherein an intervention is performed on a battery module comprising the following steps: switching off the at least one pump of the battery module in question in order to stop the supply of electrolyte to the cell arrangement; short-circuiting the battery module in question when the terminal voltage of the battery module in question has fallen below a predefined value; performing measures; switching on the at least one pump of the battery module in question; and opening the short circuit of the battery module in question.

### FIELD

The invention relates to a redox flow battery system and a method of operating a redox flow battery system, wherein the redox flow battery system comprises a plurality of battery modules connected in series, and wherein the method relates to reducing or eliminating imbalances between battery modules connected in series occurring during charging and discharging of the battery system, maintaining a battery module or decoupling one or more battery modules in order to optimize partial load mode.

### BACKGROUND

Redox flow battery systems and methods for reducing or eliminating imbalances occurring between battery modules connected in series during charging and discharging of the battery system are known from the prior art. For example, DE 10 2020 108 053 A1 discloses such a system and such a method. Measures for reducing or eliminating said imbalances are usually referred to as ‘balancing’.

### SUMMARY

It is the object of the invention to provide a redox flow battery system which is simpler in structure than the systems known from the prior art, and to provide a method for operating such a system.

According to the invention, the object is achieved by a redox flow battery system and by methods according to the independent claims. Further advantageous embodiments of the present invention can be found in the dependent claims.

### BRIEF DESCRIPTION OF THE DRAWINGS

In the following, the invention is explained with reference to figures. The figures show in detail:

FIG. 1 Battery module;

FIG. 2 Redox flow battery system according to the prior art;

FIG. 3 Charge/discharge cycles without balancing;

FIG. 4 Charge/discharge cycles with balancing according to the prior art;

FIG. 5 Redox flow battery system according to the invention;

FIG. 6 Charge/discharge cycles with balancing according to the invention;

FIG. 7 Charge/discharge cycles with balancing according to the invention;

FIG. 8 Charge/discharge cycles with balancing according to the invention;

FIG. 9 Terminal voltage curve during a balancing intervention according to the invention.

### DETAILED DESCRIPTION

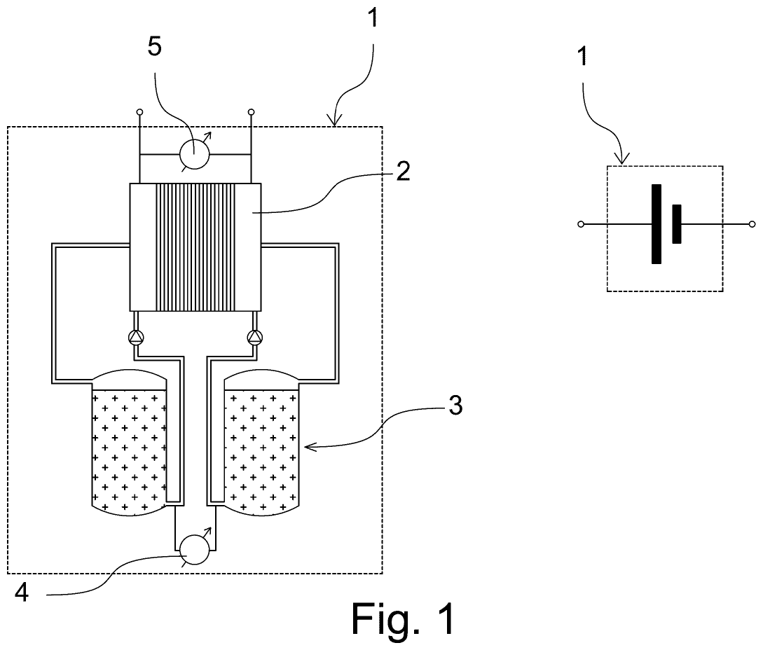

FIG. 1 shows a schematic representation of a battery module on the left side. The battery module is designated with 1. The battery module comprises a cell arrangement, designated with 2, a tank device, designated with 3, and a measuring device for detecting a controlled variable. The cell arrangement 2 is an arrangement of a large number of redox flow cells, which can be arranged as desired. For example, it could be a single cell stack, a series connection of several stacks, a parallel connection of several stacks, or a combination of series and parallel connection of several stacks. The tank device 3 is used to store the electrolyte and to supply the cell arrangement 2 with electrolyte. With a few exceptions, the tank device 3 comprises at least two tanks, a pipe system for connecting the tanks to the cell arrangement 2 and pumps for supplying the electrolyte. Here, FIG. 1 shows two separate pumps. The electrolyte could just as well be pumped with a double-head pump, i.e. with two pumps that are driven by a common motor. The tank device 3 is designed in such a way that it can supply all cells of the cell arrangement 2 with electrolyte.

The battery module 1 shown in FIG. 1 comprises two measuring devices for providing a measured variable that represents a measure of the state of charge of the associated battery module (SoC-State of Charge). The measuring device, designated with 4, is a measuring device for providing the so-called open circuit voltage (OCV). The OCV value is a measure of the state of charge of the battery module (SoC). The measuring device, designated with 5, is a measuring device for providing the terminal voltage of the cell arrangement 2 and thus also of the battery module 1. When charging or discharging the battery module 1, the terminal voltage differs from the open circuit voltage by the voltage that drops across the internal resistance of the cell arrangement 2. In the case of known charging or discharging current and internal resistance of the cell arrangement 2 the terminal voltage is a measure of the state of charge of the battery module.

A symbolic representation of the battery module 1 is shown on the right side of FIG. 1. The symbolic representation is used in the following.

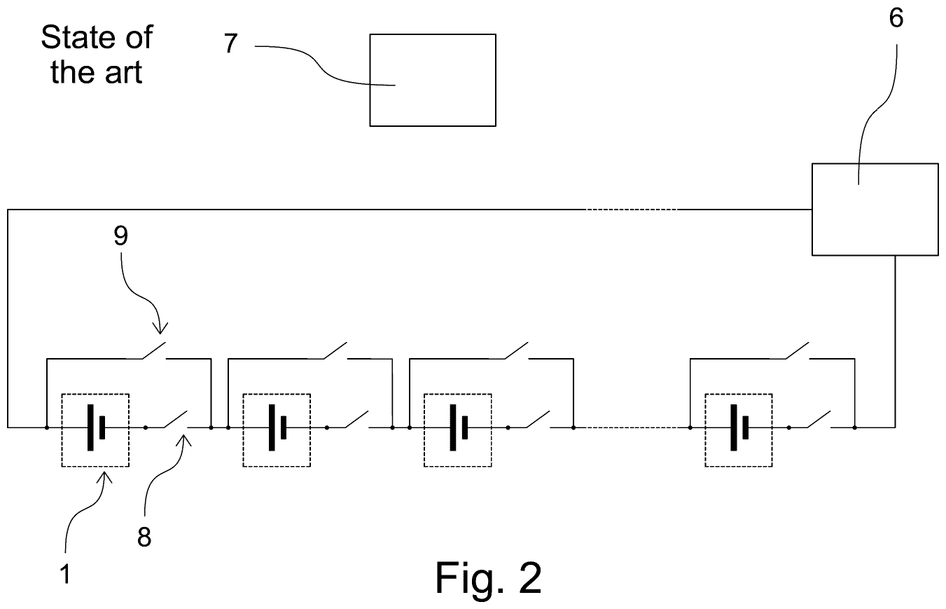

FIG. 2 shows a schematic representation of a battery system according to the prior art. The battery system comprises at least two battery modules, one of which is designated with 1, a bidirectional power conversion system (PCS), designated with 7, and a control device, designated with 8. The battery modules 1 are connected in series and connected to the conversion system 7. FIG. 2 shows four battery modules, wherein the dotted lines in the series connection are intended to indicate any number of additional modules. The conversion system 7 serves for connecting the battery system to the mains or to a higher-level electrical system. The battery system further comprises for each battery module 1a first switch, one of which is designated with 8, and a second switch, one of which is designated with 9. The first switch 8 is arranged in series with the battery modules 1, wherein one switch is respectively arranged in front of or behind each battery module 1. This means that the series connection of the battery modules can be interrupted with each of the first switches 8. The second switches 9 are respectively arranged in a bypass around a respective battery module 1 and the associated first switch 8. In FIG. 2, all switches 8 and 9 are shown in the open state. In reality, the switches are driven by the control device 7 in such a way that exactly one switch of each pair of switches of a first and second switch is closed and one switch is open (alternately open and closed). This means that a pair of switches has exactly two switch positions, wherein in the first switch position (first switch 8 closed and second switch 9 open) the associated battery module 1 is in the series connection of the battery system, and in the second switch position (first switch 8 open and second switch 9 closed) the associated battery module 1 is separated from the series connection of the battery system by the bypass. Thus, opening the first switch 8 while the second switch 9 is closed prevents the module from discharging via the bypass. Since the bypass represents a short circuit, such a discharge of the battery module via the bypass would moreover lead to very high currents that could damage or even destroy the battery module.

In a battery system as shown in FIG. 2 with completely identical battery modules 1, no harmful imbalance could occur. However, real battery modules 1 differ from each other due to manufacturing variations and ageing processes. In addition, different operating conditions, e.g. temperature differences between the individual modules, can cause them to behave differently. For these reasons, real battery modules have different efficiency values and different internal resistances. For a given charging or discharging current, a higher efficiency results in that the final state of the battery module in question is reached more quickly. As the same current flows through all battery modules 1 in the series connection shown in FIG. 2, the modules with high efficiency reach the final state faster than the modules with low efficiency. In order to avoid damage, the charging or discharging process must be interrupted as soon as a module reaches the respective final state. In this way, without compensating for this effect, the usable storage capacity of such a battery system is reduced with each cycle passed (“capacity fading”). The different internal resistance of the modules has a similar effect. There are upper and lower limit values for the terminal voltage, which must not be exceeded or undercut. Even with identical efficiency, a module with a higher internal resistance reaches the respective limit value of the terminal voltage more quickly during charging or discharging than a module with a lower internal resistance. If the first module reaches this limit value, the respective process must be aborted, which also leads to a reduction in the usable capacity of the battery system. Alternatively, the power of the system could be reduced. In either case, these effects lead to an impairment of the system. Balancing is intended to reduce or completely eliminate the effects described in order to keep the usable capacity of the battery system permanently at a high level or to eliminate the impairment described. On the other hand, successful balancing enables the use of cells with a comparatively high spread in terms of efficiency and/or internal resistance, which of course is reflected in reduced production costs.

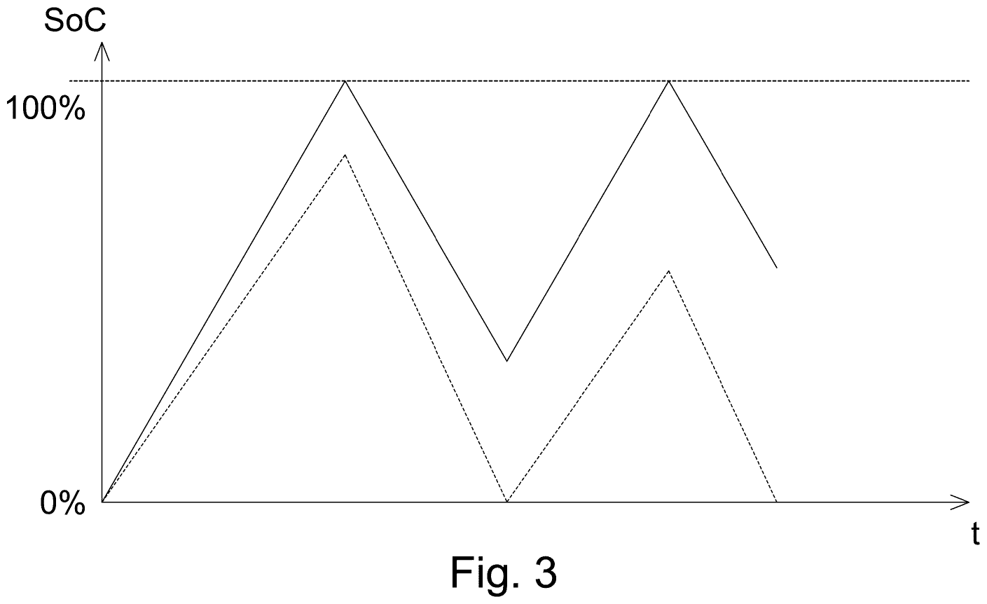

FIG. 3 shows two charge/discharge cycles of two battery modules connected in series with different efficiency values. Here, in order to illustrate this, the difference in efficiency is chosen to be very high. In real battery systems, the efficiency differences are much smaller. In FIG. 3, the SoC curve of the battery module with the higher efficiency is shown as a solid line, and the SoC curve of the battery module with the lower efficiency is shown as a dashed line. In FIG. 3, the minimum state of charge is marked with 0% and the maximum state of charge with 100%.

The more efficient battery module reaches the 100% SoC value when the less efficient battery module is not yet fully charged. Because the same current flows through both battery modules, the charging process must now be terminated. If now the battery system is to be discharged, this process starts when the less efficient battery module is not yet fully charged. Due to this unequal starting point for discharging and the lower efficiency, the less efficient battery module reaches the 0% SoC value when the more efficient battery module is not yet fully discharged.

Because the effects described act cumulative, the SoC curves of the two battery modules diverge further and further with increasing number of cycles and the usable capacity of the battery system continues to decrease.

The negative effect described can be avoided by taking balancing measures.

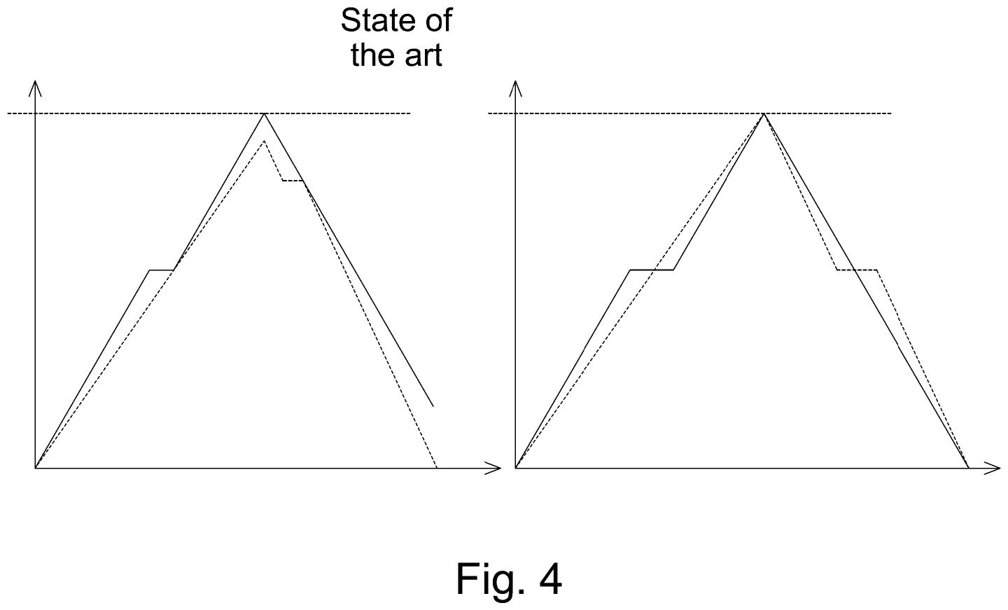

FIG. 4 shows two diagrams, each with a charge cycle of two battery modules connected in series with different efficiencies. Here, a balancing intervention is carried out respectively in one half cycle. The SoC curves shown can be generated by decoupling one or more battery modules from the series connection for a certain period of time so that they no longer participate in the charging or discharging of the other battery modules during this time. Ideally, the SoC curve for the decoupled modules is horizontal (self-discharge can be neglected). For this purpose, the first and second switches 8 and 9 are used in a battery system as shown in FIG. 2.

The more efficient battery module is decoupled during the charging half-cycle and the less efficient battery module is decoupled during the discharging half-cycle. The difference between the two diagrams is due to the different decoupling times.

In the left diagram in FIG. 4, the battery module in question is only decoupled until the two curves equalize. For example, during charging, the efficient battery module is decoupled until the less efficient battery module reaches the same state of charge that the more efficient battery module currently exhibits.

In the right diagram in FIG. 4, the battery module in question is decoupled for longer so that the two curves of the battery modules intersect. For example, in the charging half-cycle, the more efficient battery module is decoupled until the less efficient battery module has gained a sufficiently high “advance” during charging so that the more efficient battery module catches up the less efficient battery module just at the 100% SoC value. Such a balancing intervention could be described as a kind of temporary overcompensation, because equalization only occurs some time after the intervention.

The inventors have recognized that a battery system of the type can be constructed more simply by dispensing with the switches 8 for interrupting the series connection, wherein the balancing interventions are carried out differently than is known from the prior art. This is explained in more detail below. The inventors have also recognized that a battery system constructed according to the invention enables the decoupling of individual or several battery modules for maintenance purposes or for the optimization of partial load mode. This is explained in more detail following the description of the balancing interventions.

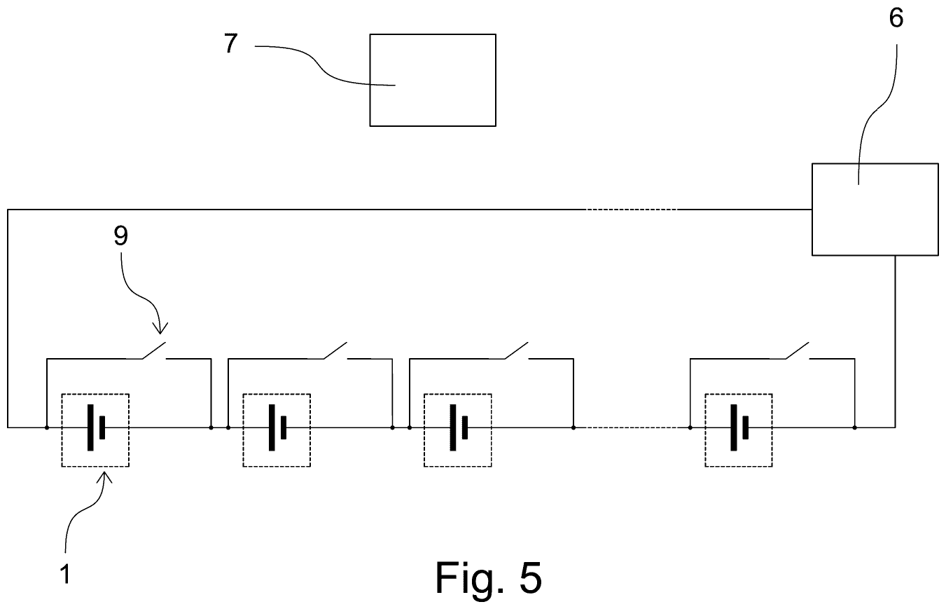

FIG. 5 shows a battery system according to the invention, which differs from the battery system shown in FIG. 2 in that the switches 8 for interrupting the series switches are missing, and in that the control device 7 is designed in such a way that it can carry out the balancing interventions or maintenance interventions or optimization interventions described below. A battery system which is suitable for carrying out the method according to the invention thus comprises means for short-circuiting each battery module. The simplest embodiment of such means is shown in FIG. 5 and comprises a short-circuit line and a switch 9, which is arranged in the short-circuit line. The switch 9 can be a relay or a semiconductor arrangement for switching. More complex means for short-circuiting are also conceivable. For example, in parallel to the battery string a short-circuit rail could be provided, to which individual battery modules can be connected with the aid of two switches.

The balancing interventions according to the invention are characterized in that they are only triggered during discharging of the battery system. As a result, in a cyclically operated battery system, either all balancing interventions only take place in the discharging half-cycles or, if the application of the battery system permits, the battery system is briefly switched to discharging during the charging half-cycle if a balancing intervention becomes necessary during the charging half-cycle. In the second case, the battery system is switched back to charging after or during the balancing intervention.

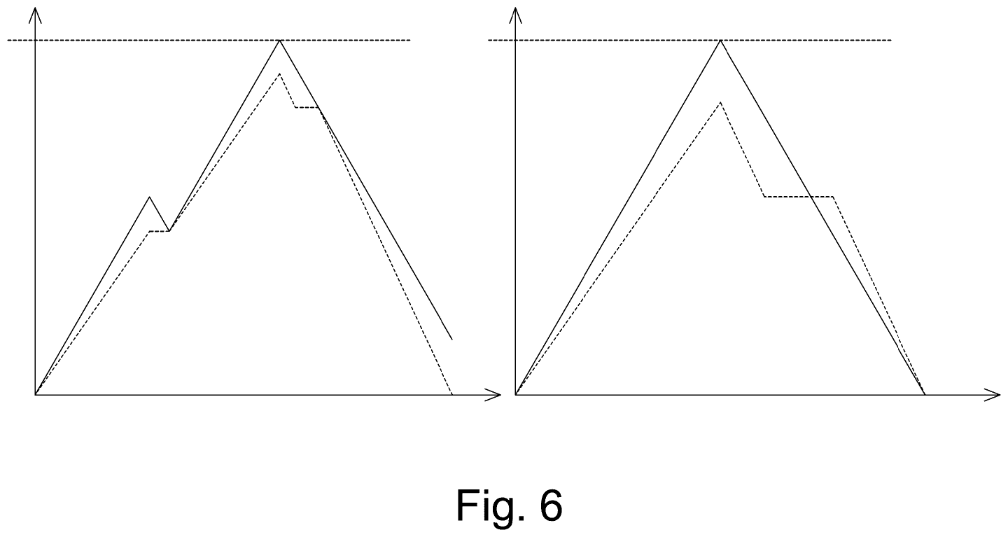

FIG. 6 shows charge/discharge cycles with balancing interventions according to the invention.

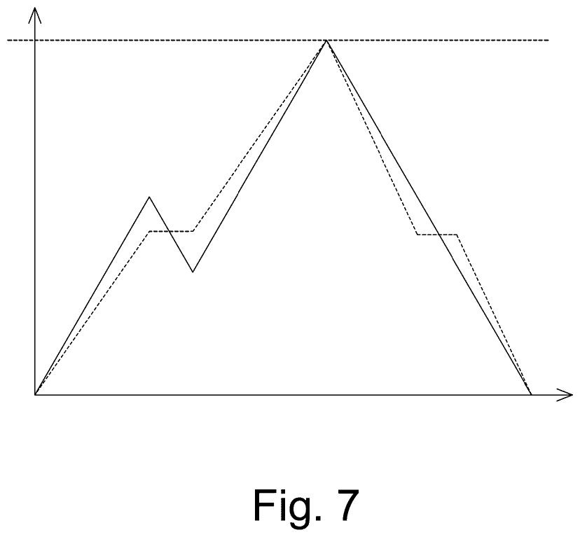

In the discharge half-cycle, the SoC curves do not differ from the SoC curves shown in FIG. 4. In the left diagram, the interventions continue until the two SoC curves equalize each other. In the charging half-cycle, it is switched to discharging during the intervention, wherein only the more effective battery module actually experiences a significant discharge. In the right diagram a balancing intervention only takes place in the discharging half-cycle. The intervention is of the “overcompensation” type. FIG. 7 shows another charge-discharge cycle with balancing interventions according to the invention. There is one intervention in each half cycle. Both interventions are of the “overcompensation” type. Due to the balancing intervention of the “overcompensation” type in the charging half-cycle the charge/discharge cycle is significantly extended.

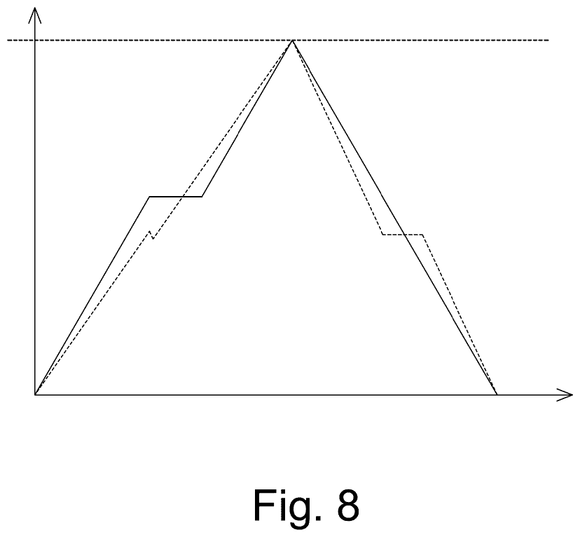

FIG. 8 shows another charge-discharge cycle with balancing interventions according to the invention. In contrast to FIG. 7, it is not the less efficient but the more efficient battery module that is short-circuited in the charging half-cycle. As in FIG. 7, the battery system is switched to discharging during the intervention, but only for a short time. Subsequently it is switched back to charging. The period of time for which it is switched to discharging can be very short. It only needs to be long enough to carry out the first two steps of the balancing intervention (see next section). Both interventions are of the “overcompensation” type. The embodiment shown in FIG. 8 is characterized by a shorter cycle time compared to the embodiment shown in FIG. 7.

The sequence of a balancing intervention according to the invention is described in more detail below. Here, it is assumed that the battery system is in discharge mode and that a balancing intervention is to be carried out on at least one battery module. The balancing intervention comprises the following steps:
Switching off the pumps of the battery module in question
Short-circuiting the battery module in question if the terminal voltage of the battery module in question has fallen below a predefined value
Waiting until the balancing final state has been reached
Switching on the pumps of the battery module in question
Opening the short circuit of the battery module in question

In the step “Waiting until the balancing final state has been reached”, the battery system is either discharged as shown in FIGS. 6 and 7, wherein the discharge current flows through all battery modules with the exception of the battery module on which the balancing intervention is carried out, or, as shown in FIG. 8 in the charging half-cycle, the battery system is switched to charging after a short discharge phase. In this case too, during the step “Waiting until the balancing final state has been reached”, the discharging or charging current flows through all battery modules with the exception of the battery module on which the balancing intervention is carried out.

The final balancing state can be an equalization or an overcompensation.

Because the internal resistance of the battery modules is much greater than the resistance of the associated short-circuit lines, the discharge current flows (almost completely) past the short-circuited battery module through the closed short-circuit line, whereby the desired final state of the balancing intervention is achieved over time. A balancing intervention according to the invention can also be carried out simultaneously at several battery modules.

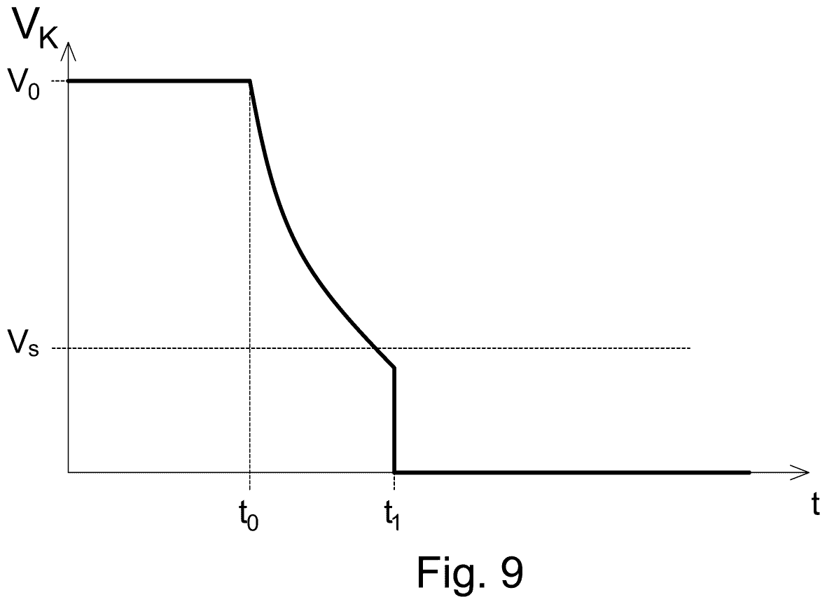

The processes in the battery module on which a balancing intervention according to the invention is carried out are explained in more detail with reference to FIG. 9. FIG. 9 shows the course of the terminal voltage V_{K} of the battery module in question as a function of time t. Prior to the balancing intervention, the battery module in question has the terminal voltage Vo. Vo depends, among other things, on the state of charge of the battery module in question. At time to, the pumps of the battery module in question are switched off so that no more electrolyte is supplied to the cell arrangement. As a result, the electrolyte in the cell arrangement discharges very quickly, because no “fresh” electrolyte is supplied. This leads to a very rapid reduction in the terminal voltage. If the terminal voltage has fallen below the predefined threshold voltage Vₛ, the battery module in question is short-circuited. In the illustration in FIG. 9, this occurs at time t₁. This causes the terminal voltage to collapse completely. This state is maintained until the desired final state of the balancing intervention has been reached. During this entire time, no significant amount of “fresh” electrolyte may be supplied to the cell arrangement of the battery module in question. This can be ensured, for example, by locking the pumps or closing a valve arranged in the supply line. The aforementioned measures may then be understood to be included in the step “Switching off the pumps of the battery module in question”.

During a very short time interval directly after short-circuiting, the entire remaining energy content of the cell arrangement of the battery module in question is converted into heat in the cell arrangement. The energy content must be sufficiently small to prevent damage to the cell arrangement. This is ensured by selecting a sufficiently low threshold voltage Vₛ, because the energy content of the cell arrangement scales with the terminal voltage. The threshold voltage Vₛ can therefore be determined on the basis of energetic considerations, wherein at least the following variables must be taken into account: Electrolyte volume in the cell arrangement, structure of the cell arrangement (including number of cells, electrode shape, material of the electrodes, thermal coupling of the electrodes to the environment), discharge current and state of charge. Due to the complexity of the possible influencing factors, an experimental validation of the effectiveness of the specified threshold voltage Vₛ is recommended.

The criterion “When the terminal voltage of the relevant battery module has fallen below a predefined value” can also be implemented by allowing a sufficiently long time to elapse between switching off the pumps and short-circuiting, i.e. by selecting a sufficiently long time interval Δt=t₁−t₀. Here, Δt to be selected depends, among others, on the state of charge of the battery module in question at time t₀ and the discharge current flowing through the battery modules in the time interval between t₀ and t₁. In the battery systems investigated by the inventors, Δt was in the range of a few seconds. This means that the method according to the invention can also be carried out without measuring and detecting the terminal voltage of the battery module in question.

The described balancing interventions according to the invention can advantageously be combined with other known types of balancing interventions, e.g. with balancing interventions in which a load is connected in parallel with the battery module in question. In this case, the balancing interventions during discharging could be realized with the interventions according to the invention, and the balancing interventions during charging by the aforementioned parallel connection of a load. In this way, switching to discharge mode can be avoided in the charging half-cycle. Auxiliary systems of the battery modules, such as the pumps, can be considered as loads. However, this can also be an electrical resistor, so that the energy dissipated by balancing is converted into heat.

A battery system according to the invention is also suitable for carrying out maintenance work on at least one battery module. In this case, only the step “Waiting until a balancing final state has been reached” is replaced by the step “Performing maintenance measures on the battery module in question”. The maintenance measures can be all possible measures that repair the battery module in question after a fault or prevent future faults. It may also involve the complete replacement of the battery module in question. The new battery module then takes the place of the battery module in question (and is addressed as such in the following process steps).

In addition, the battery system according to the invention is suitable for decoupling one or more battery modules from the series connection in order to make operation in partial load mode more efficient. Decoupling reduces the internal resistance of the battery system, thereby reducing losses. This simply replaces the step “Waiting until a balancing final state has been reached” with the step “Operating the battery system in the partial load mode”.

In order to encompass all these possibilities, the step “Waiting until a balancing final state has been reached” is addressed in the independent claim as “Performing measures”. In the claims dependent therefrom, the measures are then specified as “Waiting until a balancing final state has been reached” or as “Performing maintenance measures on the battery module in question” or as “Operating the battery system in partial load mode”.

It should be noted that the two subsequent steps “Switching on the pumps of the battery module in question” and “Opening the short circuit of the battery module in question” can be initiated at the same time or executed one after the other. The sequence of the mentioned steps does not matter as long as the time between the two steps is not too long.

These two steps recouple the battery module that was previously decoupled by the first two steps back into the series connection. If the intervention was a balancing intervention, this of course ensures that the recoupled battery module has a suitable SoC. With the two other types of intervention described, care must be taken to ensure that coupling only takes place when the SoC of the battery module to be coupled in corresponds approximately to the SoC of the other battery modules. This means that the SoC of the battery module to be coupled in should not deviate by more than 10%-preferably not more than 5%—from the SoC of the other battery modules when coupling in. The SoC can be further adjusted by a subsequent balancing intervention.

A further embodiment of the method according to the invention comprises the following steps in the order indicated:
Switching off the pumps of the battery module in question
Short-circuiting the battery module in question when the terminal voltage of the battery module in question has fallen below a predefined value
Carrying out measures
Switching on the pumps of the battery module in question
Measuring the current flowing through the cell arrangement of the battery module in question
Opening the short circuit of the battery module in question as soon as the measured current has exceeded a predefined threshold value

The advantage of this embodiment is that a jump in the voltage of the battery system can be minimized when the short circuit is opened.

It should be mentioned that the method according to the invention can also be used in battery systems in which the battery modules comprise cell arrangements that comprise several sub-cell arrangements extending in parallel. U.S. Pat. No. 10,263,270 B2, for example, discloses such a battery system. Here, the individual sub-cell arrangements can also be short-circuited individually, wherein the short-circuiting can take place simultaneously or one after the other. Appropriate means for short-circuiting must then be provided.

In order for the method according to the invention to be carried out, the control device 7 must be designed accordingly. Here, the control device controls at least the pumps and the means 9 for short-circuiting the individual battery modules and, if necessary, other means provided in order to stop the supply of electrolyte to the cell arrangement 2. If necessary, the control device 7 also detects the terminal voltages of the battery modules, i.e. it is connected to the measuring devices 5 for determining the terminal voltage. Furthermore, a computer program installed in the control device is provided for carrying out the steps of the method according to the invention. The computer program according to the invention can be stored on a data carrier.

### LIST OF REFERENCE SYMBOLS

1 Battery module
2 Cell arrangement
3 Tank device
4 Measuring device for determining the OCV
5 Measuring device for determining the terminal voltage
6 Bidirectional conversion system (PCS)
7 Control device
8 Switch for interrupting the series connection
9 Means for short-circuiting a battery module

1. A method of operating a redox flow battery system, comprising at least two battery modules, a bidirectional conversion system, and a control device,
wherein the at least two battery modules are connected in series and connected to the bidirectional conversion system, and
wherein, for each battery module of the at least two battery modules, a short circuit for the battery module is provided,
wherein each battery module comprises a cell arrangement with a plurality of redox flow cells, a tank device for storing electrolyte and for supplying the cell arrangement with the electrolyte, and at least one pump for conveying the electrolyte, and
wherein at least one battery module of the at least two battery modules is subject to an intervention which comprises the following steps:
switching off the at least one pump of the respective battery module in order to stop the supply of the electrolyte to the cell arrangement;
short-circuiting the respective battery module when a terminal voltage of the respective battery module has fallen below a predefined value;
performing measures;
switching on the at least one pump of the respective battery module; and
opening the short circuit of the respective battery module.

2. The method according to claim 1, wherein the intervention comprises the following steps in the order indicated:
switching off the at least one pump of the respective battery module to stop the supply of electrolyte to the cell arrangement;
short-circuiting the respective battery module when the terminal voltage of the respective battery module has fallen below a predefined value;
performing measures;
switching on the at least one pump of the respective battery module;
measuring a current flowing through the cell arrangement of the respective battery module; and
opening the short circuit of the respective battery module as soon as the measured current exceeds a predefined threshold value.

3. The method according to claim 1, wherein the performing measures comprises waiting until a balancing final state has been reached.

4. The method according to claim 1, wherein the performing measures comprises carrying out maintenance measures on the respective battery module.

5. The method according to claim 1, wherein the performing measures comprises operating the redox flow battery system in a partial load mode.

6. The method according to claim 1, wherein the redox flow battery system is in a discharge mode prior to the intervention.

7. The method according to claim 1, wherein the redox flow battery system is in a charging mode prior to the intervention, and
wherein the intervention comprises, as a first step:
switching the battery system to a discharge mode.

8. The redox flow battery system configured to carry out the method according to claim 1.

9. A computer program for carrying out the steps of the method according to claim 1.

10. A data carrier on which the computer program according to claim 9 is stored.

11. The method according to claim 2, wherein the performing measures comprises waiting until a balancing final state has been reached.

12. The method according to claim 2, wherein the performing measures comprises carrying out maintenance measures on the respective battery module.

13. The method according to claim 2, wherein the performing measures comprises operating the redox flow battery system in a partial load mode.
